(19) United States
(12) Patent Application Publication
(10) Pub. No.: US 2012/0173891 A1
(43) Pub. Date: Jul. 5, 2012

(54) CIRCUIT FOR CLEARING CMOS DATA

(75) Inventors: XIAN-WEN MO, Shenzhen City (CN); SHUANG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/985,358

(22) Filed: Jan. 6, 2011

(30) Foreign Application Priority Data
Dec. 29, 2010 (CN) 201010612538.X

(51) Int. Cl. G06F 1/26

(52) U.S. Cl. 713/300

(57) ABSTRACT

A circuit includes a computer reset button, a computer standby power, and a relay. The relay includes a coil, a first contact connected to a complementary metal oxide semiconductor (CMOS) clearing signal pin of a computer, a second contact connected to a system reset pin of the computer, and a control portion. A first terminal of the coil is connected to the computer standby power. A second terminal of the coil is grounded. A first terminal of the control portion is grounded through the computer reset button. When the computer standby power works, the second terminal of the control portion is connected to the second contact. When the computer standby power does not work, the second terminal of the control portion is connected to the first contact.

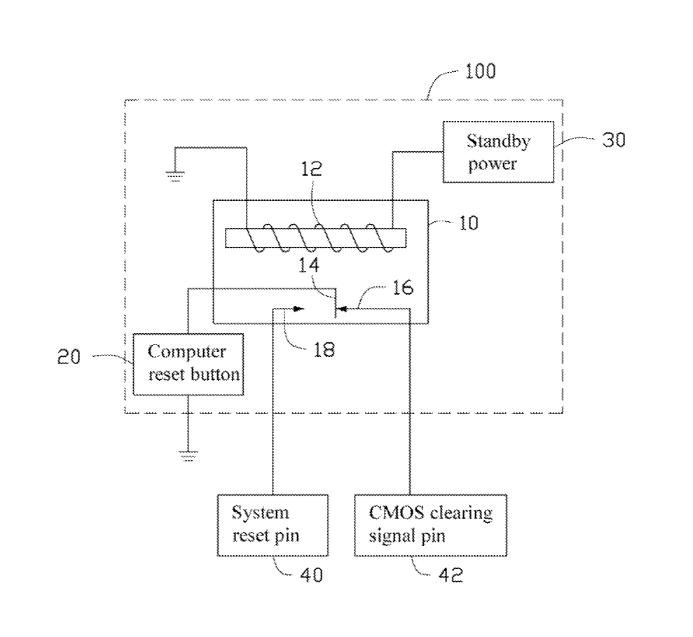

### BACKGROUND

1. Technical Field

The present disclosure relates to a circuit for clearing complementary metal oxide semiconductor (CMOS) data.

2. Description of Related Art

When basic input/output system (BIOS) settings or the CMOS chip, of a computer, are to be cleared, a jumper can be used to short-circuit certain pins on the motherboard of the computer. However, to get to the motherboard, screws on the computer must be unscrewed and removed, which is time-consuming and inefficient. Therefore there is room for improvement in the art.

### BRIEF DESCRIPTION OF THE DRAWING

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The drawing is a circuit diagram of a circuit for clearing complementary metal oxide semiconductor (CMOS) data.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

Referring to the drawing, an exemplary embodiment of a circuit 100 for clearing complementary metal oxide semiconductor (CMOS) data includes a relay 10, a computer reset button 20, and a standby power 30. The standby power 30 is a 5 volt standby power from a motherboard of the computer. The relay 10 includes a coil 12, a control portion 14, a first contact 16, and a second contact 18. A first terminal of the coil 12 is grounded. A second terminal of the coil 12 is connected to the standby power 30. A first terminal of the control portion 14 is connected to the first contact 16. A second terminal of the control portion 14 is grounded through the computer reset button 20. The first contact 16 is connected to a CMOS clearing signal pin 42 of a south bridge (not shown) of the computer. The second contact 18 is connected to a system reset pin 40 of the computer.

When the standby power 30 works, there is current passing through the coil 12. A magnetic field is formed around the coil 12. The first terminal of the control portion 14 is disconnected from the first contact 16, but connected to the second contact 18 by virtue of the magnetic force field of the coil 12. The system reset pin 40 is grounded through the computer reset button 20. When the computer reset button 20 is pressed, the computer system is reset.

When the standby power 30 does not work, there is no current passing through the coil 12. Therefore, there is no magnetic force field formed. The first terminal of the control portion 14 is returned back to keep a connection state with the first contact 16. The CMOS clearing signal pin 42 is grounded through the computer reset button 20. When the computer reset button 20 is pressed, the CMOS clearing signal pin 42 is grounded. The

CMOS data of the computer are cleared.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A circuit for clearing complementary metal oxide semiconductor (CMOS) data of a computer, the circuit comprising:
a computer reset button;
a computer standby power; and
a relay comprising:
a coil comprising a first terminal connected to the computer standby power, and a second terminal connected to ground;
a first contact connected to a CMOS clearing signal pin of the computer;
a second contact connected to a system reset pin of the computer; and
a control portion comprising a first terminal grounded through the computer reset button and a second terminal;
wherein when the computer standby power works, the second terminal of the control portion is connected to the second contact, and when the computer standby power does not work, the second terminal of the control portion is connected to the first contact.

2. The circuit of claim 1, wherein when the second terminal of the control portion is connected to the second contact, and the computer reset button is pressed, the computer is reset, when the second terminal of the control portion is connected to the first contact, and the computer reset button is pressed, the CMOS data of the computer are cleared.
